(19) United States
(12) Patent Application Publication
(10) Pub. No.: US 2021/0116252 A1
(43) Pub. Date: Apr. 22, 2021

(54) LANE TRACKING SYSTEM AND METHOD

(71) Applicant: Continental Automotive Systems, Inc., Auburn Hills, MI (US)

(72) Inventor: Matthew Donald Berkemeier, Beverly Hills, MI (US)

(73) Assignee: Continental Automotive Systems, Inc., Auburn Hills, MI (US)

(21) Appl. No.: 16/656,133

(22) Filed: Oct. 17, 2019

(51) Int. Cl. G01C 21/32; G06K 9/00; G06F 16/29; G05D 1/02

(52) U.S. Cl. CPC G01C 21/32; G06K 9/00798; G05D 2201/0213; G06F 16/29; G05D 1/0274; G06K 9/00818

(57) ABSTRACT

A method for detecting lane boundaries includes operating a vehicle on a road that has a lane marking in a visible condition. A position of a stationary object and a position of the lane marking are detected. Data regarding the positions of the stationary object and the lane marking are stored. The vehicle is operated on the road having the lane marking in a not visible condition while referencing the stored data.

### BACKGROUND

Autonomous and semi-autonomous vehicles rely on numerous sensors and detectors to gather information about an environment. For example, autonomous vehicles may detect lane markings on the road to help keep the vehicle in marked lanes.

### SUMMARY

In one exemplary embodiment, a method for detecting lane boundaries includes operating a vehicle on a road that has a lane marking in a visible condition. A position of a stationary object and a position of the lane marking are detected. Data regarding the positions of the stationary object and the lane marking are stored. The vehicle is operated on the road having the lane marking in a not visible condition while referencing the stored data.

In a further embodiment of any of the above, the vehicle is an autonomous vehicle.

In a further embodiment of any of the above, the stationary object is one of a guard rail, a sign, a road edge, an overpass, a building, a sign, a pole, a tree, and an image corner detected by a computer vision algorithm.

In a further embodiment of any of the above, multiple stationary objects are detected.

In a further embodiment of any of the above, the lane marking is a painted lane line.

In a further embodiment of any of the above, the detecting step is performed by at least one of a radar detector, a lidar detector, and a camera.

In a further embodiment of any of the above, global position system (GPS) data is stored with the positions of the stationary object and the lane marking.

In a further embodiment of any of the above, the vehicle is configured to correct a position of the vehicle on the road in the not visible condition based on the stored data.

In a further embodiment of any of the above, the not visible condition is one of the lane markings worn off the road and precipitation obscuring the lane markings.

In a further embodiment of any of the above, the detecting and storing steps repeat in an iterative fashion during the visible condition.

In another exemplary embodiment, a system for detecting lane boundaries includes a detector and a global position system (GPS) mounted on a vehicle. A computing module is in communication with the detector and the GPS. The computing module is configured to determine a position of a stationary object and a position of the lane marking relative to one another based on data from the detector when the lane marking is in a visible condition. The relative positions of the lane marking and the stationary object are stored. The stored relative positions when the lane marking is in a not visible condition is accessed.

In a further embodiment of any of the above, the vehicle is an autonomous vehicle.

In a further embodiment of any of the above, the stationary object is one of a guard rail, a sign, a road edge, an overpass, a building, a sign, a pole, a tree, and an image corner detected by a computer vision algorithm.

In a further embodiment of any of the above, the computing module is configured to determine the position of multiple stationary objects.

In a further embodiment of any of the above, the lane marking is a painted lane line.

In a further embodiment of any of the above, the detector includes at least one of a radar detector, a lidar detector, and a camera.

In a further embodiment of any of the above, the computing module is configured to store GPS data with the positions of the stationary object and the lane marking.

In a further embodiment of any of the above, the vehicle is configured to correct a position of the vehicle on the road in the not visible condition based on the stored data.

In a further embodiment of any of the above, the not visible condition is one of the lane markings worn off the road and precipitation obscuring the lane markings.

In a further embodiment of any of the above, the computing module is configured to update the stored data periodically.

### BRIEF DESCRIPTION OF THE DRAWINGS

The disclosure can be further understood by reference to the following detailed description when considered in connection with the accompanying drawings wherein:

FIG. 1 schematically illustrates an example vehicle and environment.

FIG. 2 summarizes an example method for detecting lane boundaries.

### DETAILED DESCRIPTION

The subject invention provides a system and method for detecting lane markings when they are not visible, such as in the snow. The system detects and stores the position of lane markings on the road in relation to stationary objects, such as guard rails, when the lane markings are visible. The system then relies on the stored information to know where the lane markings are located when they are not visible.

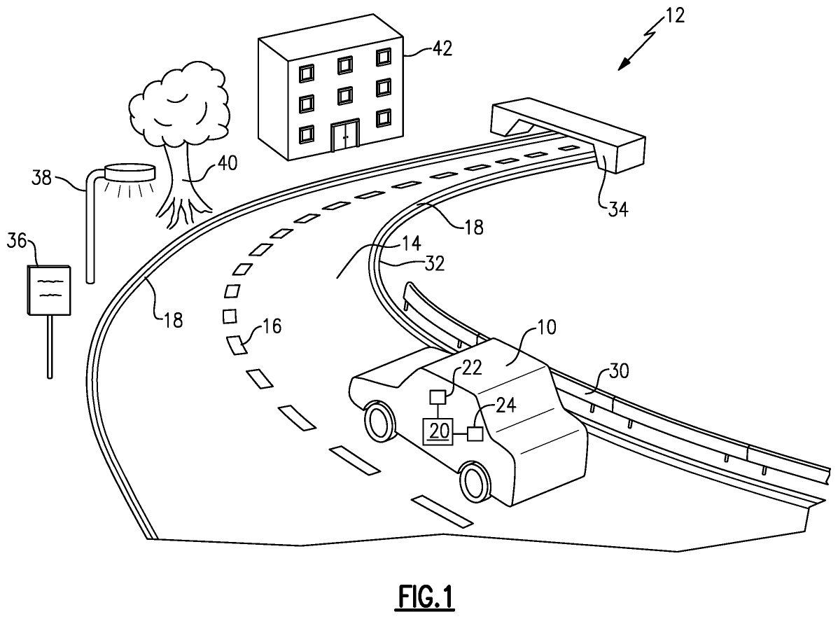

FIG. 1 illustrates an example vehicle 10 in an environment 12. The environment 12 includes a road 14. The vehicle 10 may be a fully autonomous or partially autonomous vehicle, for example. In one example, the vehicle 10 is a vehicle having a lane assist function. The road 14 includes lane markings 16, 18. In one example, the lane marking 16 is a center lane line, while the lane markings 18 are lane boundaries. Although a two lane road 14 is illustrated, this disclosure may apply to roads having additional lanes and multiple types of lane markings.

The environment 12 may include several static objects in addition to the road 14. For example, guard rails 30 may line all or part of the road 14. An edge of the road 32 may be a gravel or grass boundary along the road 14. An overpass 34 may be located near the road 14. Other stationary object, such as signs 36, poles 38, trees 40, and buildings 42 may be positioned near the road. The pole 38 may be a streetlight or telephone pole, for example. In other examples, the stationary object may be a “feature” detected by computer vision algorithms, sometimes known as a “corner” in an image. Some such computer vision algorithms that detect corners include scale-invariant feature transform (SIFT), speeded-up robust features (SURF), Oriented FAST and rotated BRIEF (ORB), and others. The vehicle 10 relies on these and other stationary objects for tracking lane markings 16, 18.

The vehicle 10 includes a computing module 20 in communication with at least one detector 22 and a global positioning system (GPS) 24. The detector 22 may include at least one of a camera, a LIDAR detector, a RADAR detector. In one example, the detector 22 includes only a camera. In another example, the detector 22 includes only a LIDAR detector. In a further example, the detector 22 includes a combination of a RADAR detector with a camera and/or a LIDAR detector. The computing module 20 determines and stores information about the lane markings 16, 18 based on information from the detector 22. The computing module 20 stores a relationship between the lane markings 16, 18, and any detected stationary object along with GPS data. The computing module 20 then relies on the stored information about the lane markings and stationary objects at times when the lane markings 16, 18 are not visible. The vehicle 10 may then correct a position of the vehicle 10 on the road 14 when the lane markings 16, 18 are not visible based on the stored data. For example, if the vehicle 10 is an autonomous vehicle, the data is used to keep the vehicle 10 in a lane. If the vehicle 10 is a partially autonomous vehicle, the data may be used to keep the vehicle 10 in a lane or to alert a driver if the vehicle 10 veers out of a lane.

This information regarding lane markings 16, 18 in the environment 12 is determined by the detectors 22 sending information to the computing module 20. The detectors 22 may communicate with the computing module 14 via communication hardware, or may communicate wirelessly. The system may use one or more of the following connection classes, for example: WLAN connection, e.g. based on IEEE 802.11, ISM (Industrial, Scientific, Medical Band) connection, Bluetooth® connection, ZigBee connection, UWB (ultrawide band) connection, WiMax® (Worldwide Interoperability for Microwave Access) connection, infrared connection, mobile radio connection, and/or radar-based communication.

The system, and in particular the computing module 14, may include one or more controllers comprising a processor, memory, and one or more input and/or output (I/O) device interface(s) that are communicatively coupled via a local interface. The local interface can include, for example but not limited to, one or more buses and/or other wired or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

The computing module 14 may include a hardware device for executing software, particularly software stored in memory, such as the computer vision algorithm. The computing module 14 may include a custom made or commercially available processor, a central processing unit (CPU), an auxiliary processor among several processors associated with the computing module 14, a semiconductor based microprocessor (in the form of a microchip or chip set), or generally any device for executing software instructions. The memory can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory may incorporate electronic, magnetic, optical, and/or other types of storage media. Note that the memory can also have a distributed architecture, where various components are situated remotely from one another, but can be accessed by the processor.

The software in the memory may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

The controller can be configured to execute software stored within the memory, to communicate data to and from the memory, and to generally control operations of the computing module 14 pursuant to the software. Software in memory, in whole or in part, is read by the processor, perhaps buffered within the processor, and then executed. This software may be used to determine the location of lane markings relative to other stationary objects, for example.

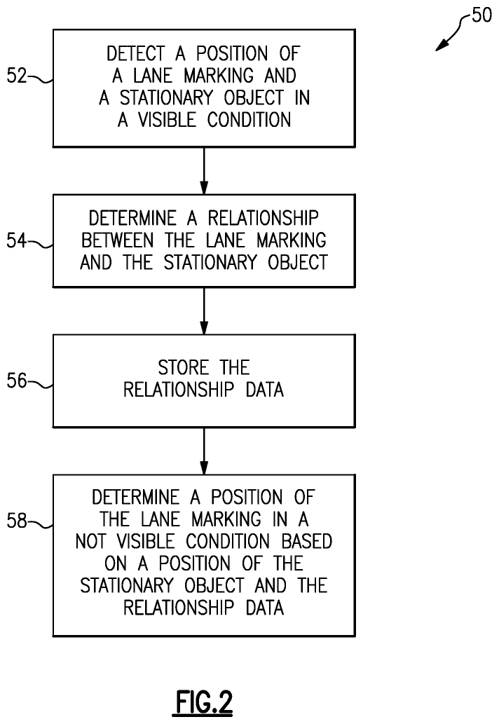

FIG. 2 summarizes an example method 50 of determining lane marking locations. The detector 22 detects a position of a lane marking 16, 18, and detects a stationary object at 52. The stationary object may be a guard rail 30, an edge of the road 32, an overpass 34, a sign 36, a pole 38, a tree 40, or building 42, for example. The stationary object may be anything that does not move relative to the road 14. Next, the computing module 20 determines a relationship between the lane marking 16, 18 and the stationary object at 54. For example, the computing module 20 calculates the location of the lane marking 16, 18 relative to the stationary object. The computing module 20 may do this with respect to several different stationary objects. The computing module 20 stores the relationship between the lane marking 16, 18 and the stationary object along with data from the GPS 24 at 56. Thus, the computing module 20 creates a database of lane marking locations relative to stationary objects. When the vehicle 10 is operating in a condition where the lane markings 16, 18 are not visible, the computing module 20 determines the position of the lane markings 16, 18 by comparing the detected location of a stationary object with the stored data.

In some examples, the system essentially operates in two modes. The first mode is gathering and storing the data, and includes steps 52, 54, and 56. The first mode is used when the lane markings 16, 18 are visible. The second mode is using the stored data to determine the locations of lane markings 16, 18 when the lane markings are not visible. The second mode includes step 58. In some examples, the vehicle 10 operates in the first mode as a default. The vehicle may be in the first mode all the time. In other examples, a driver of the vehicle 10 may activate the first mode, such as when driving on frequently travelled roads. In other examples, the vehicle 10 may activate the first mode when the vehicle 10 detects the vehicle 10 is on a road that is often travelled via the GPS 24. The first mode may repeat in an iterative fashion. This will repeatedly update the stored data, which may assist in accuracy of the data if any stationary objects are not permanent, such as construction signs. The vehicle 10 may automatically activate the second mode when the lane markings are not visible, or a driver of the vehicle 10 may manually activate the second mode. In some examples, the vehicle 10 may utilize different sensors or detector 22 in the first mode and the second mode.

The disclosed system and method assist autonomous and partially autonomous vehicles in detecting the location of lane markings when the lane markings are not visible. This may be useful when the lane markings are covered with snow, or have worn off, for example. Known systems rely on another mapping vehicle with expensive, highly accurate equipment to create a map, then sharing the map with other vehicles. Other known systems rely on a network of vehicles to build a map, and then combine information to create a map and share the map with individual vehicles. The disclosed system and method does not rely on other vehicles or transferring information to the vehicle from another vehicle or other information source. The disclosed system and method uses inexpensive equipment that is already on the vehicle to create a map of commonly travelled roads for when the lane markings are not visible.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although an example embodiment has been disclosed, a worker of ordinary skill in this art would recognize that certain modifications would come within the scope of the claims. For that reason, the following claims should be studied to determine their true scope and content.

What is claimed is:

1. A method for detecting lane boundaries, comprising:
operating a vehicle on a road having a lane marking in a visible condition;
detecting a position of a stationary object and a position of the lane marking;
storing data regarding the positions of the stationary object and the lane marking; and
operating the vehicle on the road having the lane marking in a not visible condition while referencing the stored data.

2. The method of claim 1, wherein the vehicle is an autonomous vehicle.

3. The method of claim 1, wherein the stationary object is one of a guard rail, a sign, a road edge, an overpass, a building, a sign, a pole, a tree, and an image corner detected by a computer vision algorithm.

4. The method of claim 1, comprising detecting multiple stationary objects.

5. The method of claim 1, wherein the lane marking is a painted lane line.

6. The method of claim 1, wherein the detecting step is performed by at least one of a radar detector, a lidar detector, and a camera.

7. The method of claim 1, comprising storing global position system (GPS) data with the positions of the stationary object and the lane marking.

8. The method of claim 1, wherein the vehicle is configured to correct a position of the vehicle on the road in the not visible condition based on the stored data.

9. The method of claim 1, wherein the not visible condition is one of the lane markings worn off the road and precipitation obscuring the lane markings.

10. The method of claim 1, wherein the detecting and storing steps repeat in an iterative fashion during the visible condition.

11. A system for detecting lane boundaries, comprising:
a detector and a global position system (GPS) mounted on a vehicle;
a computing module in communication with the detector and the GPS, the computing module configured to:
determine a position of a stationary object and a position of the lane marking relative to one another based on data from the detector when the lane marking is in a visible condition;
store the relative positions of the lane marking and the stationary object; and
access the stored relative positions when the lane marking is in a not visible condition.

12. The system of claim 11, wherein the vehicle is an autonomous vehicle.

13. The system of claim 11, wherein the stationary object is one of a guard rail, a sign, a road edge, an overpass, a building, a sign, a pole, a tree, and an image corner detected by a computer vision algorithm.

14. The system of claim 11, wherein the computing module is configured to determine the position of multiple stationary objects.

15. The system of claim 11, wherein the lane marking is a painted lane line.

16. The system of claim 11, wherein the detector includes at least one of a radar detector, a lidar detector, and a camera.

17. The system of claim 11, wherein the computing module is configured to store GPS data with the positions of the stationary object and the lane marking.

18. The method of claim 11, wherein the vehicle is configured to correct a position of the vehicle on the road in the not visible condition based on the stored data.

19. The method of claim 11, wherein the not visible condition is one of the lane markings worn off the road and precipitation obscuring the lane markings.

20. The method of claim 11, wherein the computing module is configured to update the stored data periodically.
